(19) United States
(12) Patent Application Publication
(10) Pub. No.: US 2015/0309628 A1
(43) Pub. Date: Oct. 29, 2015

(54) PANEL PACKAGE STRUCTURE

(71) Applicant: Industrial Technology Research Institute, Hsinchu (TW)

(72) Inventors: Kuo-Feng Chen, Taichung City (TW); Shu-Hsing Lee, Hsinchu City (TW); Meng-Ying Chuang, New Taipei City (TW); Chih-Chia Chang, Hsinchu County (TW)

(21) Appl. No.: 14/519,149

(22) Filed: Oct. 21, 2014

(30) Foreign Application Priority Data
Apr. 25, 2014 (TW) 103115014

(51) Int. Cl. G06F 3/047

(52) U.S. Cl. CPC G06F 3/047

(57) ABSTRACT

A package structure includes a first panel having a first surface and a second surface opposite to the first surface, a second panel having a third surface and a fourth surface opposite to the third surface, a first adhesive layer disposed between the first surface of the first panel and the third surface of the second panel, and a frame disposed on the side of the first panel and the first adhesive layer and disposed on the second surface of the first panel and the third surface of the second panel. The difference of the adhesive strength between the frame and the first adhesive layer is equal to or larger than 0.5N/25 mm. The width of the first panel is larger than the width of the frame, and the ratio of the width of the first panel to the width of the frame is between 15 and 83.

### CROSS-REFERENCE TO RELATED APPLICATION

This application claims the priority benefit of Taiwan application serial no. 103115014, filed on Apr. 25, 2014. The entirety of the above-mentioned patent application is hereby incorporated by reference herein and made a part of this specification.

### BACKGROUND

1. Field of the Disclosure

The present disclosure relates to a panel package structure, in particular, to a touch display panel package structure.

2. Description of Related Art

Following the fast advances in the electronic technology and in the display technology, the handheld electronic products in recent years are developed toward compactness and lightweight, and it is common to incorporate the foldable display into the portable electronic products. In addition, the display of the electronic products may be equipped with the touch function to become the touch display, which further boosts up the uses and practicality of the electronic products.

In general, wrinkles, scratches or cracks often occur at the folding region(s) of the packaging of the foldable display panels, thus deteriorating the durability of the electronic products. Taking the lamination packaging of the touch display panel as an example, after folding, wrinkles may occur in the laminated layers of the touch display panel, which causes deviation of the internal electrode layer or other functional layer(s) within the touch display panel. It is vital that the touch display panels are able to withstand repeated folding in order to ensure the quality of the touch display panel products.

### SUMMARY

One embodiment of the disclosure provides a panel package structure. The panel package structure includes a first panel having a first surface and a second surface opposite to the first surface, a second panel having a third surface and a fourth surface opposite to the third surface, a first adhesive layer disposed between the first surface of the first panel and the third surface of the second panel, and a frame disposed on the side of the first panel and the first adhesive layer. The frame is also disposed on the second surface of the first panel and the third surface of the second panel. The difference of the adhesive strength between the frame and the first adhesive layer is equal to or larger than 0.5N/25 mm. The width of the first panel is larger than the width of the frame, and the ratio of the width of the first panel to the width of the frame ranges from 15 to 83.

In order to make the disclosure more comprehensible, several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 schematically illustrates a cross-sectional view of a touch display panel package structure according to an embodiment of the disclosure.

FIG. 2A schematically illustrates a top view of a touch display panel package structure according to an embodiment of the disclosure.

FIG. 2B schematically illustrates a top view of a touch display panel package structure according to one embodiment of the disclosure.

FIG. 2C schematically illustrates a top view of a touch display panel package structure according to another embodiment of the disclosure.

FIG. 2D schematically illustrates a top view of a touch display panel package structure according to one embodiment of the disclosure.

FIG. 2E schematically illustrates a top view of a touch display panel package structure according to another embodiment of the disclosure.

FIG. 2F schematically illustrates a top view of a touch display panel package structure according to one embodiment of the disclosure.

FIG. 2G schematically illustrates a top view of a touch display panel package structure according to another embodiment of the disclosure.

FIG. 2H illustrates a schematic diagram of the folded structure of the touch display panel package structure in FIG. 2G.

FIG. 2I schematically illustrates a top view of a touch display panel package structure according to an embodiment of the disclosure.

FIG. 3 schematically illustrates a cross-sectional view of a touch display panel package structure according to one embodiment of the disclosure.

FIG. 4 schematically illustrates a cross-sectional view of a touch display panel package structure according to another embodiment of the disclosure.

FIG. 5A schematically illustrates a cross-sectional view of a touch display panel package structure according to another embodiment of the disclosure.

FIG. 5B schematically illustrates a cross-sectional view of a touch display panel package structure according to another embodiment of the disclosure.

FIG. 6 schematically illustrates a cross-sectional view of a touch display panel package structure according to another embodiment of the disclosure.

FIG. 7 schematically illustrates a cross-sectional view of a touch display panel package structure according to another embodiment of the disclosure.

FIG. 8 shows the resistance change rates of the touch display panel package structure with the frame before folding and after folding.

FIG. 9 shows the durable folding times of the package structures of the touch display panels with the frames in different sizes.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts. The following examples are used to illustrate two or more package structures of the touch display panels with the designs of stress distribution and improved adhesion, so that the electrical properties of the panels are maintained (e.g., the wrinkles generated at the adhesive layer of the panel may affect the touch function of the panel). The sizes or proportions of the elements or parts described in the drawings are merely provided for the convenience of explanations, and should not be used to represent the actual sizes or proportions of elements or parts.

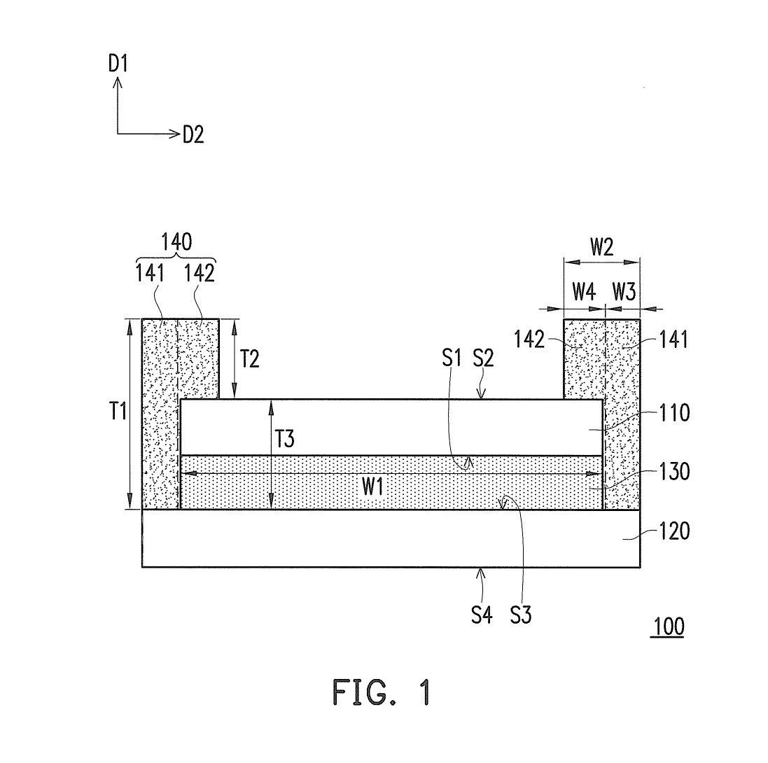

FIG. 1 schematically illustrates a cross-sectional view of a touch display panel package structure according to an embodiment of the disclosure. Referring to FIG. 1, in the present embodiment, the touch display panel package structure 100 includes a first panel 110, a second panel 120, a first adhesive layer 130, and a frame 140. The frame 140 includes a lateral frame 141 and a top frame 142. The first panel 110 has a first surface S1 and a second surface S2 opposite to the first surface S 1, while the second panel 120 has a third surface S3 and a fourth surface S4 opposite to the third surface S3. The first adhesive layer 130 is disposed between the first surface Si of the first panel 110 and the third surface S3 of the second panel 120. The first panel 110 may be, for example, a touch panel, a color filter, a planar layer, a gas barrier layer, a water barrier layer, a stress buffering layer, a scratch-resistant layer, an UV shielding layer, an anti-glare layer, an anti-fingerprint layer or an anti-reflection layer and the second panel 120 may be a display panel, or the first panel 110 may be a display panel and the second panel 120 may be a touch panel, a color filter, a planar layer, a gas barrier layer, a water barrier layer, a stress buffering layer, a scratch-resistant layer, an UV shielding layer, an anti-glare layer, an anti-fingerprint layer or an anti-reflection layer.

The lateral frame 141 is located by the sides of the first panel 110 and the first adhesive layer 130 and is located on the third surface S3 of the second panel 120. The top frame 142 is located on the second surface S2 of the first panel 110 and adjacent to the lateral frame 141. The lateral frame 141 and the top frame 142 are located in the non-functioning area of the first panel 110 and the second panel 120 (i.e. the non-display area of the display panel and the non-touch area of the touch panel), such as, the peripheral regions of the first panel 110 and the second panel 120. The frame 140 may be located by at least one side of the first panel 110 and the second panel 120.

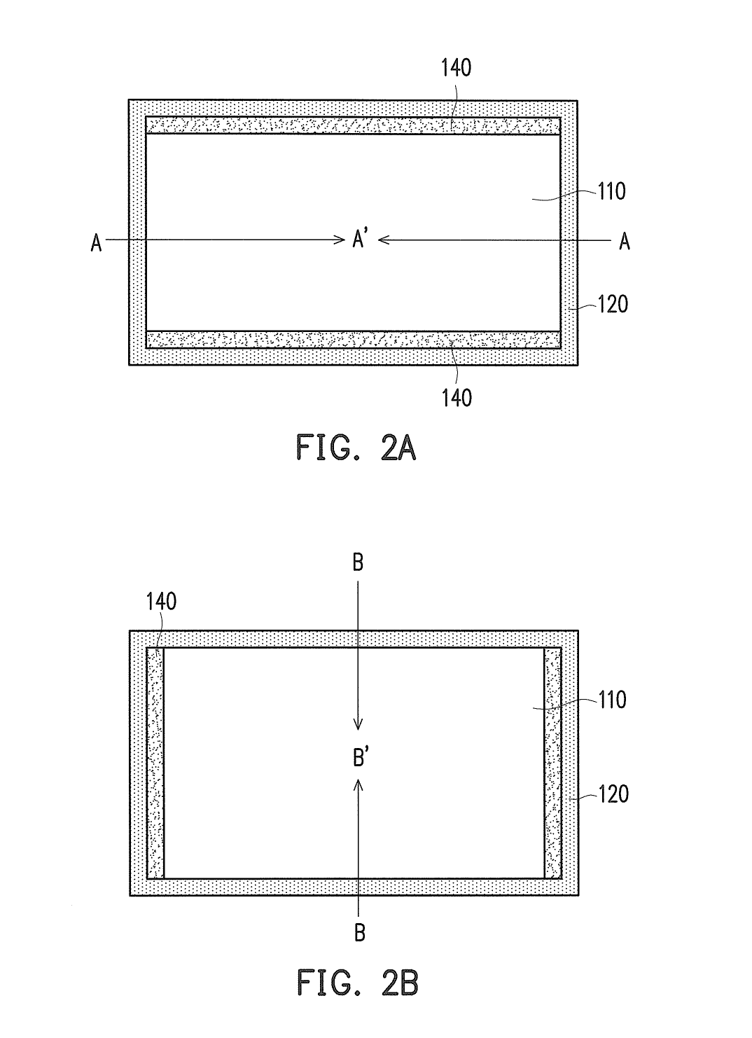

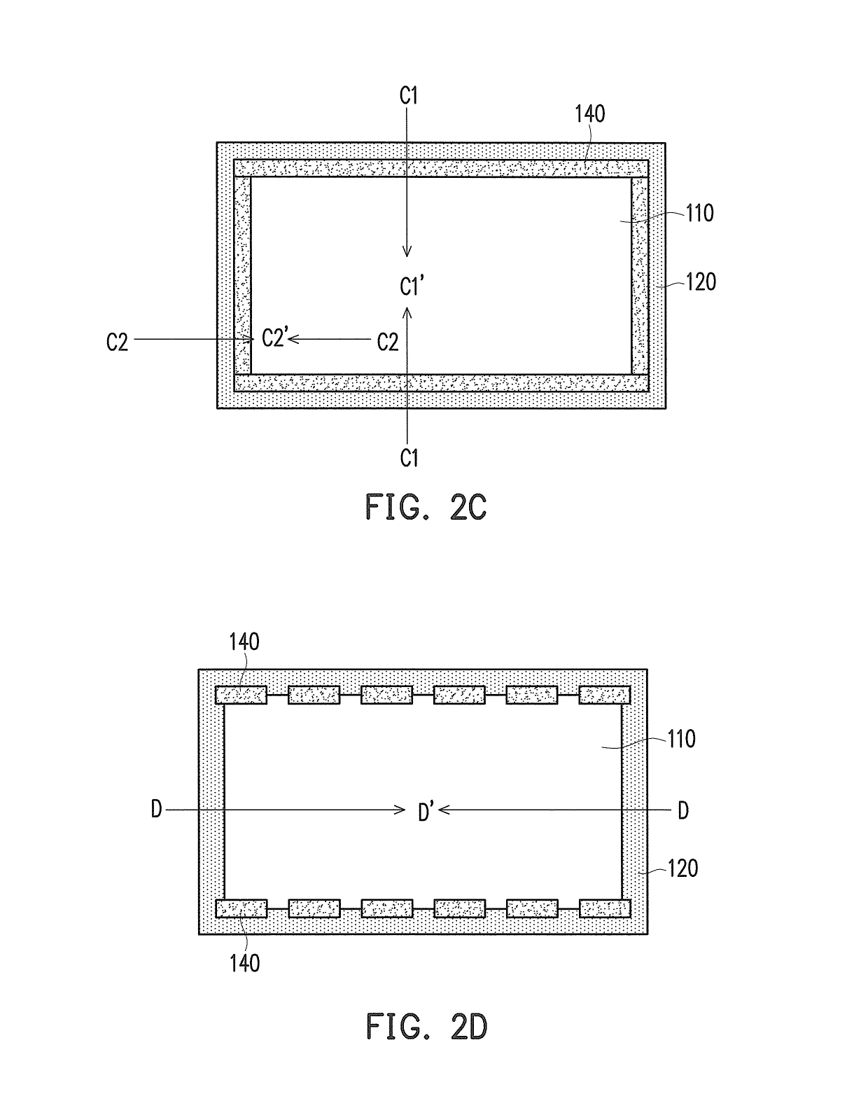

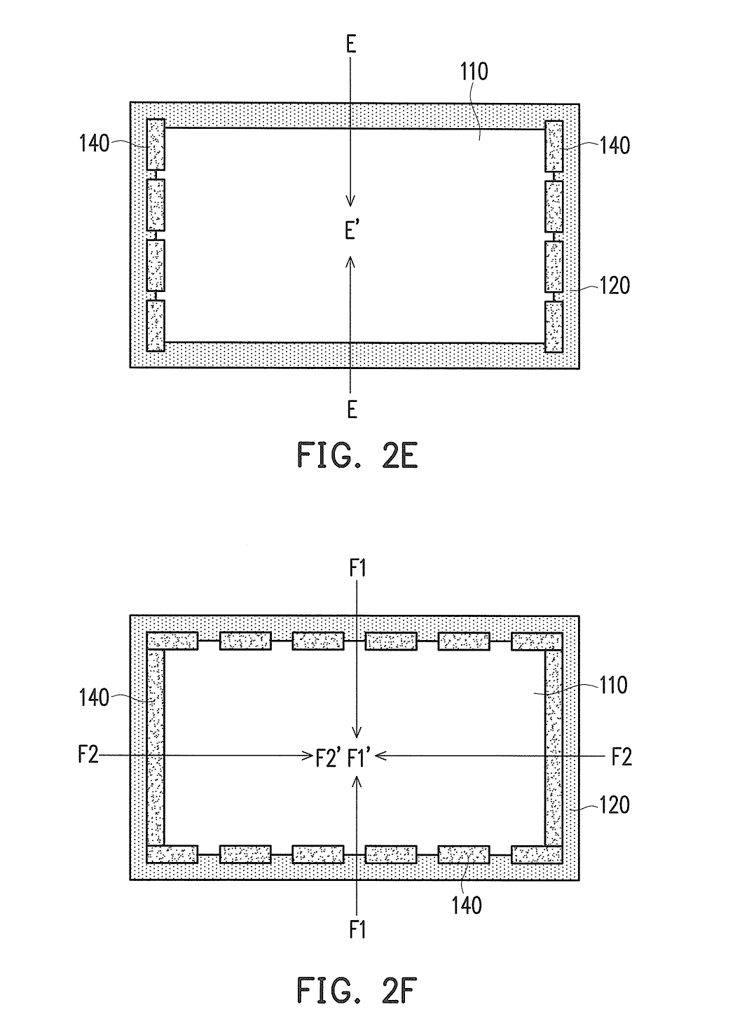

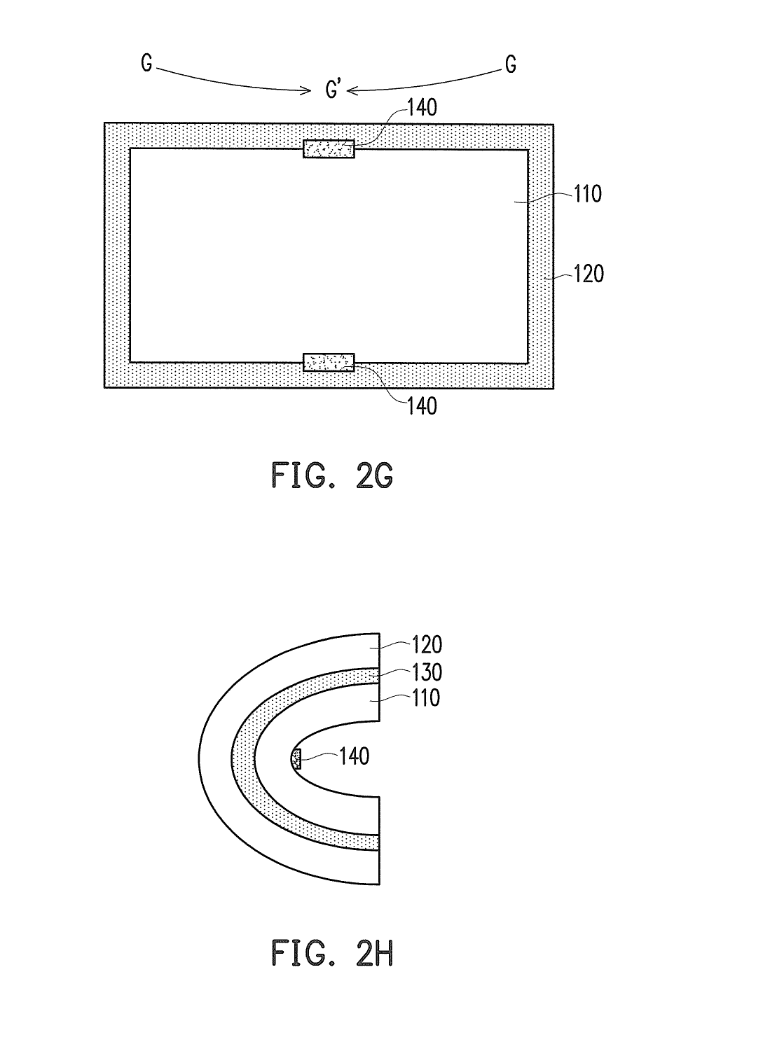

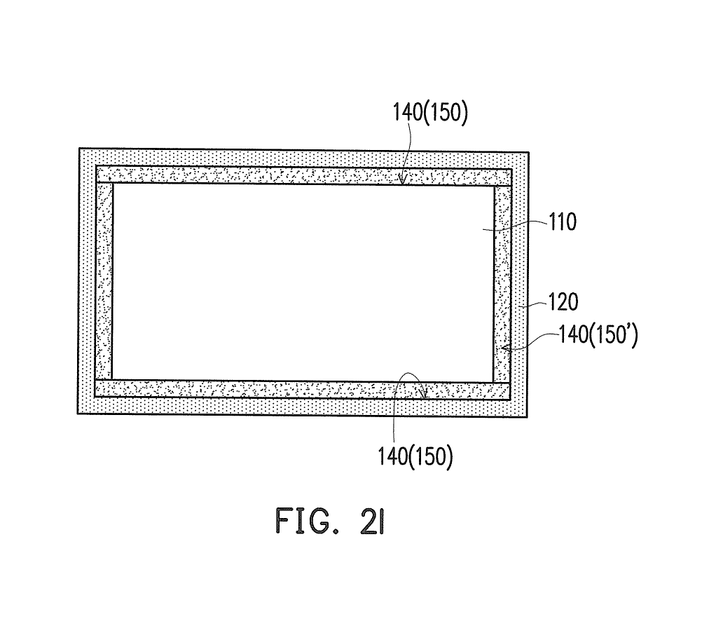

FIG. 2A schematically illustrates a top view of a touch display panel package structure according to an embodiment of the disclosure. Referring to FIG. 2A, the frame 140 is a continuous structure and they are located at two opposite sides of the four sides of the first panel 110 and the second panel 120. The frame 140 is located over the predetermined folding region(s) of the touch display panel package structure (the folding direction is to be folded from A toward A′ direction). FIG. 2B schematically illustrates a top view of a touch display panel package structure according to one embodiment of the disclosure. Different from FIG. 2A, the frame 140 in FIG. 2B is also a continuous structure, but they are located at the other two sides of the first panel 110 and the second panel 120. The frame 140 is located over the predetermined folding region(s) of the touch display panel package structure (the folding direction is to be folded from B toward B′ direction). FIG. 2C schematically illustrates a top view of a touch display panel package structure according to another embodiment of the disclosure. In FIG. 2C, the frame 140 is a continuous structure and located to cover four sides of the first panel 110 and the second panel 120, for example. In this embodiment, the four sides of the first panel 110 and the second panel 120 are predetermined folding regions (the folding direction is to be folded from C2 to C2′ direction or from Cl to C1′ direction). FIG. 2D schematically illustrates a top view of a touch display panel package structure according to another embodiment of the disclosure. Referring to FIG. 2D, the frame 140 includes discontinuous block structures and the structures are distributed over two opposite sides of the four sides of the first panel 110 and the second panel 120. The frame 140 is located over the predetermined folding region(s) of the touch display panel package structure (the folding direction is to be folded from D toward D′ direction). FIG. 2E schematically illustrates a top view of a touch display panel package structure according to another embodiment of the disclosure. Different from FIG. 2D, the frame 140 in FIG. 2E are also discontinuous block structures and the unconnected structures are distributed over the other two opposite sides of the first panel 110 and the second panel 120. The frame 140 is located over the predetermined folding region(s) of the touch display panel package structure (the folding direction is to be folded from E toward E′ direction). FIG. 2F schematically illustrates a top view of a touch display panel package structure according to another embodiment of the disclosure. The frame 140 located at two opposite sides of the first panel 110 and the second panel 120 are continuous structures, while the frame 140 located over the other two opposite sides are discontinuous block structures. The frames 140 are located in the predetermined folding regions (the folding direction is to be folded from F1 to F1′ direction or from F2 to F2′ direction). FIG. 2G schematically illustrates a top view of a touch display panel package structure according to another embodiment of the disclosure. In FIG. 2G, the frame 140 in this embodiment may be located only at the folding site of the predetermined folding region (the folding direction is to be folded from G toward G′ direction). FIG. 2H illustrates a schematic diagram of the folded structure of the touch display panel package structure in FIG. 2G. After folding, the frame 140 is located in the middle of the folded structure.

Referring to FIG. 1 again, in this embodiment, the width of the first panel 110 and the first adhesive layer 130 may be substantially the same or similar. For example, the thickness of the touch panel is 15 μm, the thickness of the display panel is 100 μm and the thickness of the first adhesive layer 130 is 25 μm. The thickness of the lateral frame 141 is T1, the direction D1 is the thickness direction of the panel package structure. Along the thickness direction D1, T1 is the thickness of the lateral frame 141, T2 is the thickness of the top frame 142, and T3 is the thickness from the third surface S3 of the second panel 120 to the second surface S2 of the first panel 110. The direction D2 is the width direction substantially perpendicular to the thickness direction D1, and the width of the first adhesive layer 130 in the width direction D2 is W1. The total width of the lateral frame 141 and the top frame 142 is W2, while the width of the lateral frame 141 is W3 and the width of the top frame 142 is W4, and W2=W3+W4. In one embodiment, the thickness T2 of the top frame 142 ranges between 10 μm to 5 mm, and the thickness T1 of the lateral frame 141 is the sum of the thickness T2 of the top frame 142 and the thickness T3 from the third surface S3 to the second surface S2 (T1=T2+T3), and the T1 is greater than T3. In one embodiment, the ratio of the width W4 of the top frame 142 to the width W3 of the lateral frame 141 is 1˜4 (W4/W3=1/1˜4/1), and the width W1 of the first adhesive layer 130 is larger than the width W2 of the frames 141/142 (W1>W2). The ratio of the width W1 of the first adhesive layer 130 and the width W2 of the frames 141/142 ranges from 15 to 83 (W1/W2=15/1˜83/1). In one embodiment, the width of the first adhesive layer 130 is substantially the same as the width of the first panel 110. However, the present disclosure is not limited by these embodiments, and the width of the first panel 110 and the width of the first adhesive layer 130 in other embodiments may be different.

The materials of the first adhesive layer 130 may be optically clear adhesives or glues. In one embodiment, for example, the first adhesive layer 130 is made of an optical adhesive of an adhesive strength of 44N/25 mm, while the lateral frame 141 and the top frame 142 may be made of elastomeric materials that are deformed under the force and bounced back to the original shape without the force. The Young's modulus of the elastomeric material(s) may be less than 10 Gpa, with the adhesive strength of 10N/25 mm˜50N/25 mm. The elastomeric materials may be chained hydrocarbon polymer materials, such as rubber adhesive materials, acrylic resin adhesive materials or silicone resin adhesive materials. The rubber adhesive materials include natural rubber and synthetic rubber, while acrylic resin adhesive materials include acrylic resins and modified acrylic resins. The material(s) of the lateral frame 141 and the top frame 142 may be non-transparent or transparent. In one embodiment, the lateral frame 141 or the top frame 142 may be of the adhesive strength of 40N/25 mm, while the difference between the adhesive strength of the first adhesive layer 130 and that of the lateral frame 141 or the top frame 142 may be at least 0.5N/25 mm or more.

FIG. 2I schematically illustrates a top view of a touch display panel package structure according to an embodiment of the disclosure. Referring to FIG. 2I, different from FIG. 2C, the frames around the panel are not made of identical materials. In FIG. 2I, the frames 140 located at the parallel two long sides of the panel are made of a first frame material 150, and the frames 140 located at the two short sides of the panel are made of a second frame material 150′. The configuration of the frames formed with different materials can be designed in correspondence with the stress the touch display panel encountered when being folded, and the characteristics of the materials should match the magnitude of the stress.

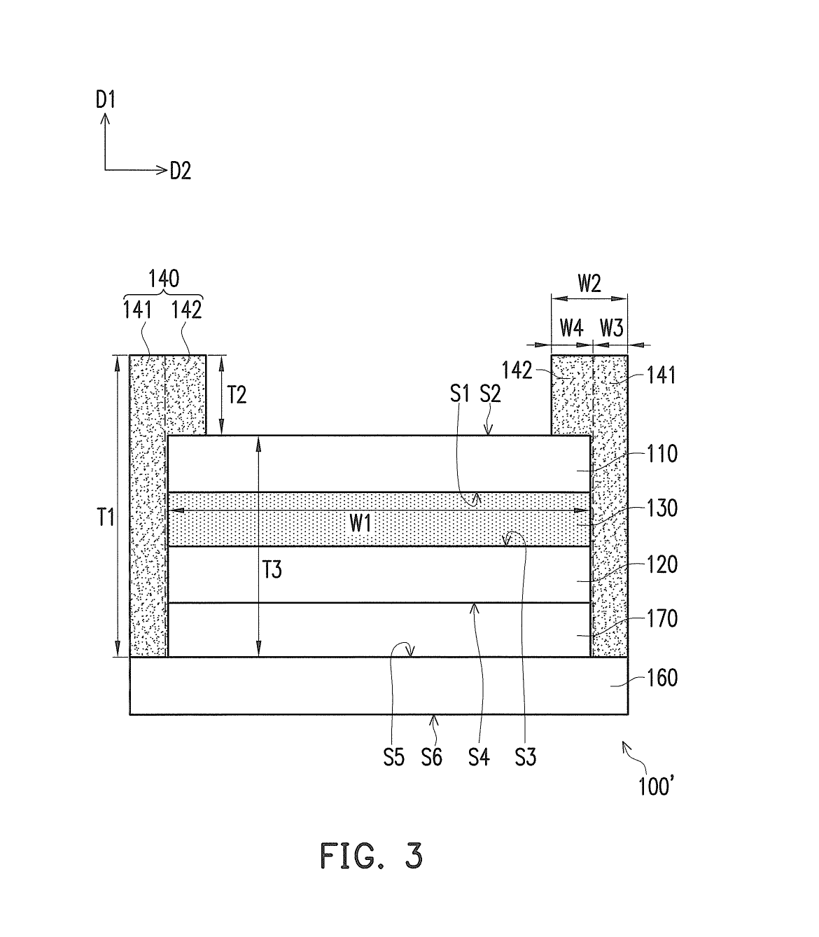

FIG. 3 schematically illustrates a cross-sectional view of a touch display panel package structure according to one embodiment of the disclosure. Referring to FIG. 3, for the touch display panel package structure 100′ of FIG. 3, the same elements as shown in the touch display panel package structure 100 of FIG. 1 are labelled with the same element numerals. Compared with the touch display panel package structure 100 of FIG. 1, the touch display panel package structure 100′ of FIG. 3 further includes a functional layer 160 and a second adhesive layer 170. The functional layer 160 has a fifth surface S5 and a sixth surface S6, and the second adhesive layer 170 is disposed between the fifth surface S5 of the functional layer 160 and the fourth surface S4 of the second panel 120. That is, the second panel 120 is disposed between the first panel 110 and the functional layer 160, the first adhesive layer 130 is interposed between the first panel 110 and the second panel 120, and the second adhesive layer 170 is disposed between the second panel 120 and the functional layer 160. The lateral frame 141 is disposed on the fifth surface S5 of the functional layer 160 and located by the sides of the first panel 110, the first adhesive layer 130, the second panel 120 and the second adhesive layer 170. The top frame 142 is disposed on the second surface S2 of the first panel 110 and next to the lateral frame 141. The first panel 110 may be, for example, a touch panel and the second panel 120 may be a display panel, or the first panel 110 may be a display panel and the second panel 120 is a touch panel. The functional layer 160 may be, for example, a polarizer, while the material of the second adhesive layer 170 may be an optically clear adhesive or glue. The first adhesive layer 130 and the second adhesive layer 170 may be formed with the same or different materials. The size ranges and/or relative proportions of the width W1 of the first adhesive layer 130, the total width W2 of the lateral and top frames 141, 142, the width W3 of the lateral frame 141 and the width W4 of the top frame 142 are the same or very similar to those described in the touch display panel package structure 100 of FIG. 1 and will not be described in details again. The thickness T1 of the lateral frame 141 in this embodiment equals to the sum of the thickness T2, the thickness of the first panel 110, the thickness of the first adhesive layer 130, the thickness of the second panel 120 and the thickness of the second adhesive layer 170. The position of the frame(s) 140 relative to the first panel 110, the second panel 120 and the functional layer 160 may refer to the top views of the package structures shown in FIGS. 2A to 2I. For example, the frames 140 may be continuous structures located at two opposite sides of the first panel 110, the second panel 120 and the functional layer 160. Alternatively, the frames 140 may also be continuous structures located at the other two opposite sides of the first panel 110, the second panel 120 and the functional layer 160, or covering four sides of the first panel 110, the second panel 120 and the functional layer 160. In addition, the frames 140 may be discontinuous block structures and located at two opposite sides of the first panel 110, the second panel 120 and the functional layer 160, while the frames 140 located at the other two opposite sides of the first panel 110, the second panel 120 and the functional layer 160 are continuous structures. Alternatively, the frame 140 may be located only at the folding site of the predetermined folding region. The materials of the frames located at different sides may be different. In another embodiment, the functional layer 160 may be a color filter. The functional layer 160 may also function as a planar layer, a gas barrier layer, a water barrier layer, a stress buffering layer, a scratch-resistant layer, an UV shielding layer, an anti-glare layer, an anti-fingerprint layer or an anti-reflection layer and the like.

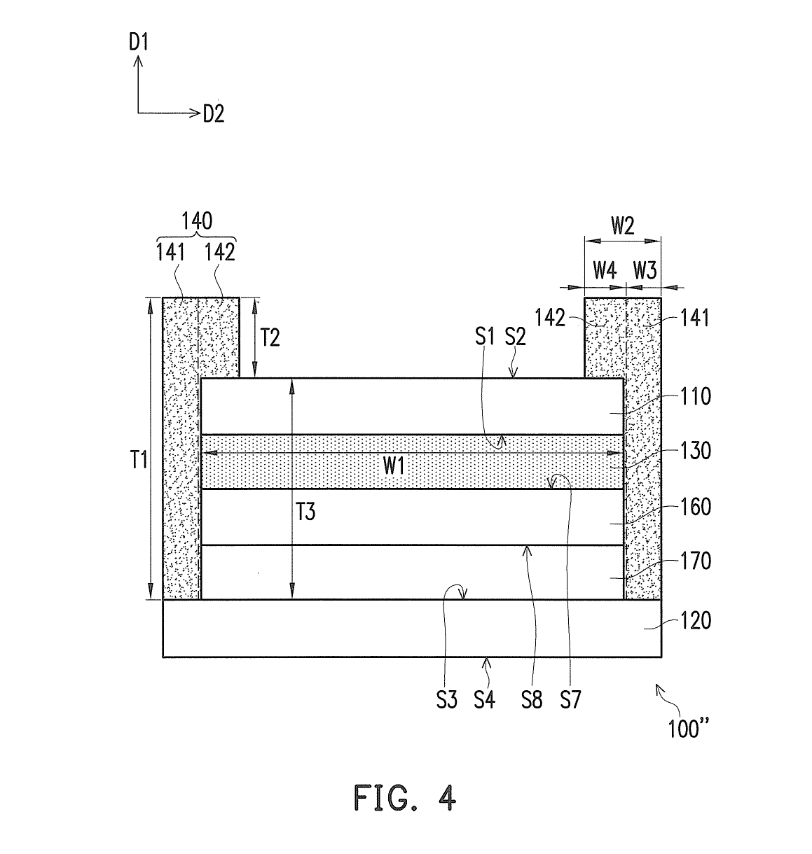

FIG. 4 schematically illustrates a cross-sectional view of a touch display panel package structure according to another embodiment of the disclosure. Referring to FIG. 4, for the touch display panel package structure 100″ of FIG. 4, the same elements as shown in the touch display panel package structure 100 of FIG. 1 are labelled with the same element numerals. Compared with the touch display panel package structure 100 of FIG. 1, the touch display panel package structure 100″ of FIG. 4 further includes a functional layer 160 and a second adhesive layer 170. The functional layer 160 has a seventh surface S7 and an eighth surface S8, and the second adhesive layer 170 is disposed between the eighth surface S8 of the functional layer 160 and the third surface S3 of the second panel 120. That is, the functional layer 160 is disposed between the first panel 110 and the second panel 120. The lateral frame 141 is disposed on the third surface S3 of the second panel 120 and located by the sides of the first panel 110, the first adhesive layer 130, the functional layer 160 and the second adhesive layer 170. The top frame 142 is disposed on the second surface S2 of the first panel 110 and next to the lateral frame 141. The first panel 110 may be, for example, a touch panel and the second panel 120 may be a display panel, or the first panel 110 may be a display panel and the second panel 120 may be a touch panel. The functional layer 160 may be a color filter, for example, while the material of the second adhesive layer 170 may be an optically clear adhesive or glue. The first adhesive layer 130 and the second adhesive layer 170 may be formed with the same or different materials. The size ranges and/or relative proportions of the width W1 of the first adhesive layer 130, the total width W2 of the lateral and top frames 141, 142, the width W3 of the lateral frame 141 and the width W4 of the top frame 142 are the same or very similar to those described in the touch display panel package structure 100 of FIG. 1 and will not be described in details again. The thickness T1 of the lateral frame 141 in this embodiment equals to the sum of the thickness T2, the thickness of the first panel 110, the thickness of the first adhesive layer 130, the thickness of the functional layer 160 and the thickness of the second adhesive layer 170. The position of the frame(s) 140 relative to the first panel 110, the second panel 120 and the functional layer 160 may refer to the top views of the package structures shown in FIGS. 2A to 2I. For example, the frames 140 may be continuous structures located at two opposite sides of the first panel 110, the second panel 120 and the functional layer 160. Alternatively, the frames 140 may also be continuous structures located at the other two opposite sides of the first panel 110, the second panel 120 and the functional layer 160, or covering four sides of the first panel 110, the second panel 120 and the functional layer 160. In addition, the frames 140 may be discontinuous block structures and located at two opposite sides of the first panel 110, the second panel 120 and the functional layer 160, while the frames 140 located at the other two opposite sides of the first panel 110, the second panel 120 and the functional layer 160 are continuous structures. Alternatively, the frame 140 may be located only at the folding site of the predetermined folding region. The materials of the frames located at different sides may be different. In another embodiment, the functional layer 160 may be a color filter. The functional layer 160 may also function as a planar layer, a gas barrier layer, a water barrier layer, a stress buffering layer, a scratch-resistant layer, an UV shielding layer, an anti-glare layer, an anti-fingerprint layer or an anti-reflection layer and the like.

FIGS. 3 and 4 are directed to the embodiments of the three-layer package structures including the first panel 110, the second panel 120 and at least one functional layer, but the present disclosure is not limited thereto. In other embodiments, the functional layer may include more than one layer and the package structure may be formed with the first panel 110, the second panel 120 and the multi-layered functional layer(s). In addition, the relative positions of the functional layer, the first panel 110 and the second panel 120 are not limited by the embodiments.

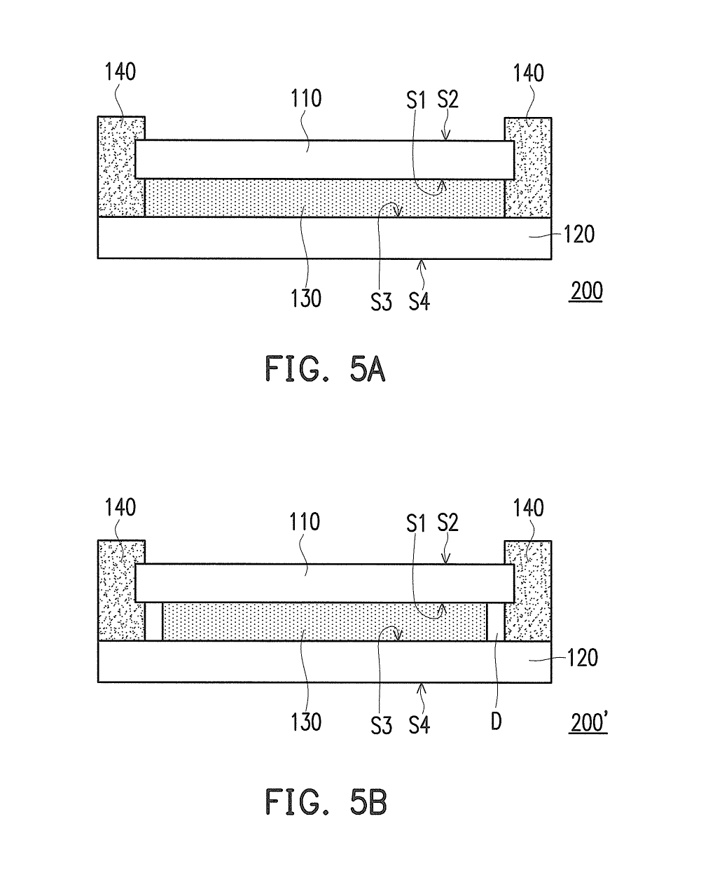

FIG. 5A schematically illustrates a cross-sectional view of a touch display panel package structure according to another embodiment of the disclosure. Refer to FIG. 5A, in the present embodiment, the touch display panel package structure 200 includes a first panel 110 and second panel 120, a first adhesive layer 130 and the frame 140. The first panel 110 has a first surface Si and a second surface S2 opposite to the first surface S1, while the second panel 120 has a third surface S3 and a fourth surface S4 opposite to the third surface S3. The first adhesive layer 130 is disposed between the first surface Si of the first panel 110 and the third surface S3 of the second panel 120. The first panel 110 may be, for example, a touch panel and the second panel 120 may be a display panel, or the first panel 110 may be a display panel and the second panel 120 is a touch panel. The first panel 110, the second panel 120 and the first adhesive layer 130 may have different widths, and the width of the first panel 110 is greater than the width of the first adhesive layer 130. The frame 140 is located by the sides of the first panel 110 and the first adhesive layer 130 and located on the third surface S3 of the second panel 120. The frame 140 is also located on the first surface S1 and the second surface S2 of the first panel 110, the frame 140 is adjacent to and in direct contact with the first adhesive layer 130. The material or the configuration of the frame 140 can be similar to the possible choices in either materials or configuration of the frame as described in the previous embodiment of FIG. 1, and will not be described in details herein again.

FIG. 5B schematically illustrates a cross-sectional view of a touch display panel package structure according to another embodiment of the disclosure. Referring to FIG. 5B, similar to the touch display panel package structure 200 of FIG. 5A, the touch display panel package structure 200′ also includes the first panel 110, the second panel 120, the first adhesive layer 130 and the frame 140. The first panel 110 has the first surface S1 and the second surface S2 opposite to the first surface S1, while the second panel 120 has the third surface S3 and the fourth surface S4 opposite to the third surface S3. The first adhesive layer 130 is disposed between the first surface S1 of the first panel 110 and the third surface S3 of the second panel 120. The first panel 110 may be, for example, a touch panel and the second panel 120 may be a display panel, or the first panel 110 may be a display panel and the second panel 120 is a touch panel. The first panel 110, the second panel 120 and the first adhesive layer 130 may have different widths, and the width of the first panel 110 is greater than the width of the first adhesive layer 130. The frame 140 is located by the sides of the first panel 110 and the first adhesive layer 130 and located on the third surface S3 of the second panel 120. The frame 140 is also located on the first surface Si and the second surface S2 of the first panel 110. Different to FIG. 5A, there is a gap D between the frame 140 and the first adhesive layer 130. The material or the configuration of the frame 140 can be similar to the possible choices in either materials or configuration of the frame as described in the previous embodiment of FIG. 1, and will not be described in details herein again.

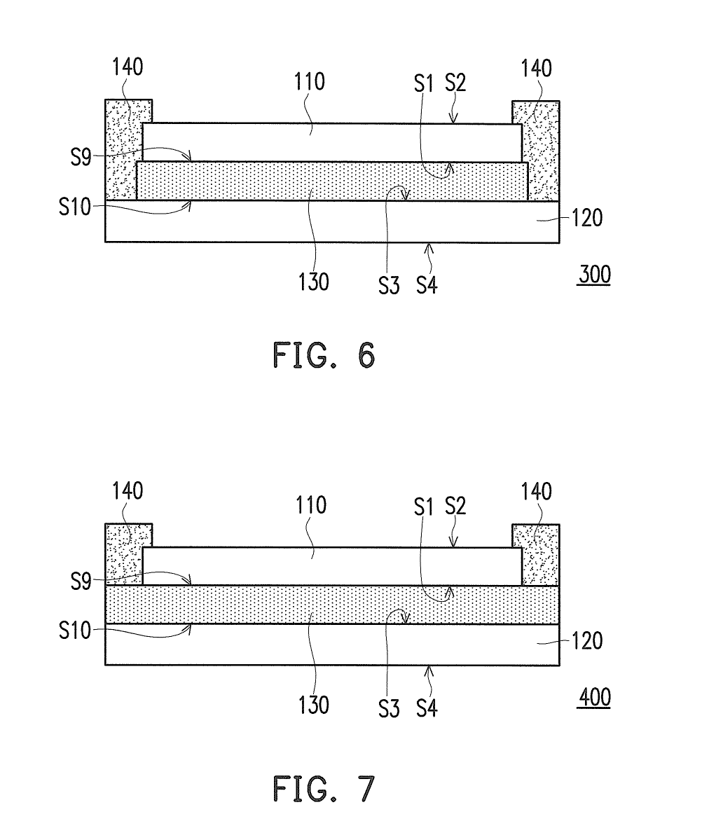

FIG. 6 schematically illustrates a cross-sectional view of a touch display panel package structure according to another embodiment of the disclosure. Referring to FIG. 6, in the present embodiment, the touch display panel package structure 300 includes the first panel 110, the second panel 120, the first adhesive layer 130 and the frame 140. The first panel 110 has the first surface S1 and the second surface S2 opposite to the first surface S1, while the second panel 120 has the third surface S3 and the fourth surface S4 opposite to the third surface S3. The first adhesive layer 130 has a ninth surface S9 and a tenth surface S10 opposite to the ninth surface S9. The first adhesive layer 130 is disposed between the first surface S1 of the first panel 110 and the third surface S3 of the second panel 120. The first panel 110 may be, for example, a touch panel and the second panel 120 may be a display panel, or the first panel 110 may be a display panel and the second panel 120 is a touch panel. The first panel 110, the second panel 120 and the first adhesive layer 130 may have different widths, and the width of the first panel 110 is smaller than the width of the first adhesive layer 130 and the width of the first adhesive layer 130 is less than the width of the second panel 120. The frame 140 is located by the sides of the first panel 110 and the first adhesive layer 130 and located on the third surface S3 of the second panel 120. The frame 140 is partially located on the second surface S2 of the first panel 110 and the ninth surface S9 of the first adhesive layer 130. The configuration of the frame 140 is the same or similar to the frame 140 disposed on the first and second panels 110, 120 of FIG. 1, and will not be described in details herein again.

FIG. 7 schematically illustrates a cross-sectional view of a touch display panel package structure according to another embodiment of the disclosure. Referring to FIG. 7, in the present embodiment, the touch display panel package structure 400 includes the first panel 110, the second panel 120, the first adhesive layer 130 and the frame 140. The first panel 110 has the first surface S1 and the second surface S2 opposite to the first surface S1, while the second panel 120 has the third surface S3 and the fourth surface S4 opposite to the third surface S3. The first adhesive layer 130 has the ninth surface S9 and the tenth surface S10 opposite to the ninth surface S9. The first adhesive layer 130 is disposed between the first surface S1 of the first panel 110 and the third surface S3 of the second panel 120. The first panel 110 may be, for example, a touch panel and the second panel 120 may be a display panel, or the first panel 110 may be a display panel and the second panel 120 is a touch panel. The first panel 110, the second panel 120 and the first adhesive layer 130 may have different widths, and the width of the first panel 110 is smaller than the width of the first adhesive layer 130 and the width of the first adhesive layer 130 is substantially equivalent to the width of the second panel 120. The frame 140 is located by the sides of the first panel 110 and partially located on the second surface S2 of the first panel 110 and on the ninth surface S9 of the first adhesive layer 130. The configuration of the frame 140 is the same or similar to the frame 140 disposed on the first and second panels 110, 120 of FIG. 1, and will not be described in details herein again.

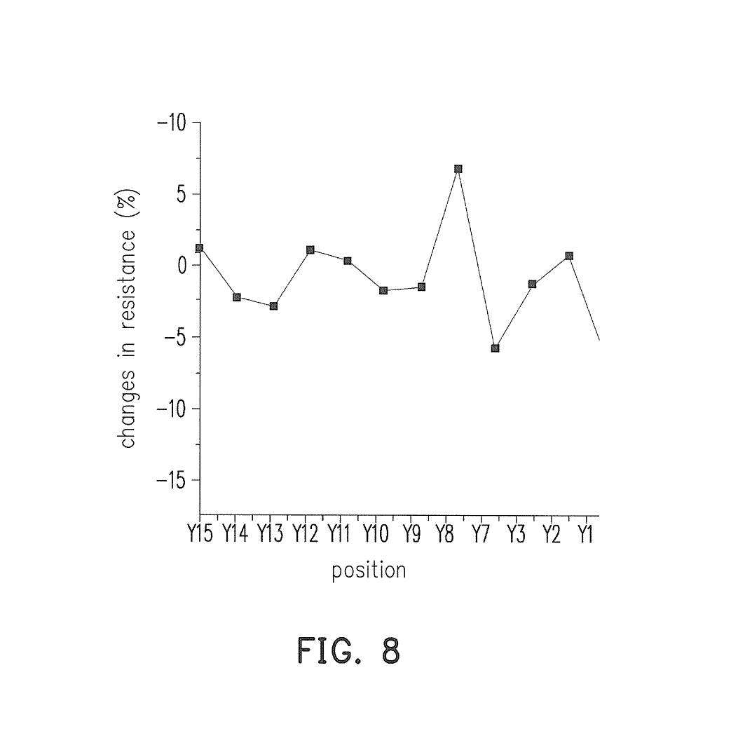

FIG. 8 shows the resistance change rates of the touch display panel package structure with the frame before folding and after folding. In this embodiment, the touch display panel package structure with the frame(s) is similar to the touch display panel package structure 100 shown in FIG. 1. The first panel 110 is a touch panel, and the second panel 120 is a display panel, the tress frame has a thickness T1 of 0.1 cm and a bending radius of 7.5 mm. The adhesive strength of the frame used in the experiments is 5N/25 mm, the first adhesive layer 130 has an adhesive strength of 44N/25 mm, with the folding times being 10,000 times, the resistance values are measured at different locations of the folded region on the first panel. As shown in the figure, the square dots represent the data collected before folding, while the round dots represent the data collected after folding. From FIG. 8, little or less changes in the resistance values are observed at the same position of the touch display panel package structure with the frame before and after folding. On the contrary, under the same conditions, larger changes in the resistance values are observed at the same position of the touch display panel package structure without the frame before and after folding.

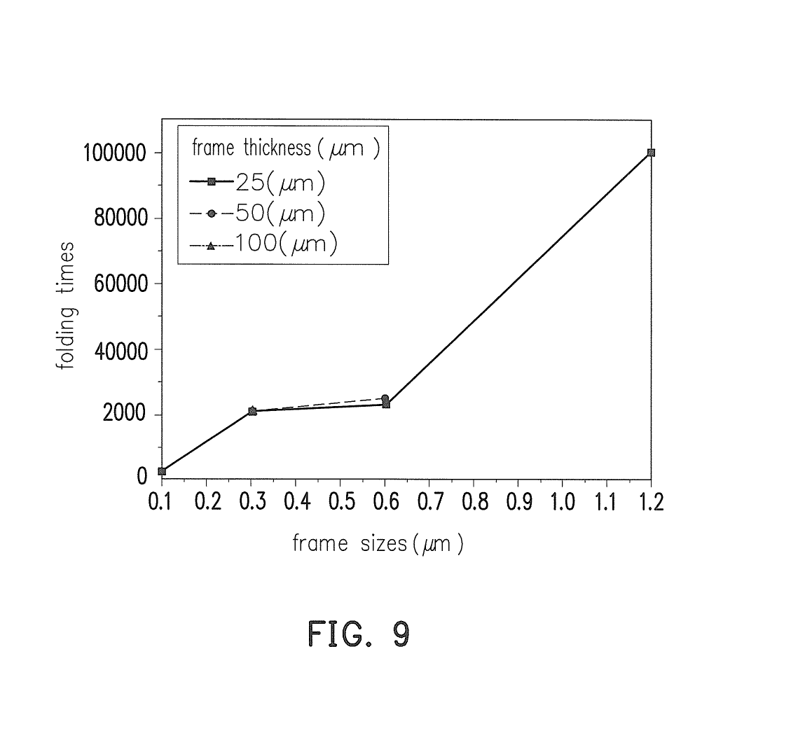

FIG. 9 shows the durable folding times of the package structures of the touch display panels with the frames in different sizes. The touch display panel package structure with the frame of this embodiment is similar to the touch display panel package structure 100 of FIG. 1. The first panel 110 is a 15 μm thick polyimide film with the size of 6 inches, and the second panel 120 is a 100 μm thick PET sheet. The first adhesive layer 130 has an adhesive strength of 12.32N/25 mm. The frame(s) used in the experiments is of an adhesive strength of 12.32N/25 mm or 24N/25 mm. The thickness T1 of the frame may be 25 μm, 50 μm or 100 μm, while the width W2 of the frame may be 0.3 cm, 0.6 cm and 1.2 cm, with a bending radius of 7.5 mm. The frame used for the structure in FIG. 9 has an adhesive strength of 24N/25 mm. The square dots shown in the figure represent the frame having a thickness T1 of 25 μm, and the data shows that the frames with larger widths is more stress-resistant and can withstand higher folding times, up to 100,000 times of folding. The round dots or triangular dots shown in the figure represent the frame having a thickness T1 of 50 μm or 100 μm, and the data shows that the frames can withstand folding times higher than 10,000 times, but far less than 100,000 times of folding. The results from FIG. 9 show that frames with larger widths can withstand higher folding times and the frames formed with the materials of higher viscosity is more stress-resistant, which improves the structural stability of the panel package structure.

In summary, through choosing the configuration of the frame and the materials for the frame and the adhesive layer, the touch display panel package structures described in the embodiments can be designed to maintain the electrical properties and characteristics of the panel even after repeatedly folding.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

what is claimed is:

1. A panel package structure, comprising:
a first panel having a first surface and a second surface opposite to the first surface;
a second panel having a third surface and a fourth surface opposite to the third surface;
a first adhesive layer disposed between the first surface of the first panel and the third surface of the second panel; and
a frame disposed by sides of the first panel and the first adhesive layer, on the second surface of the first panel and on the third surface of the second panel, wherein a difference between an adhesive strength of the frame and an adhesive strength of the first adhesive layer is equal to or larger than 0.5N/25 mm, a width of the first panel is larger than a width of the frame, and a ratio of the width of the first panel to the width of the frame ranges between 15 and 83.

2. The structure according to claim 1, wherein the frame comprises:
a lateral frame disposed by sides of the first panel and the first adhesive layer and on the third surface of the second panel; and
a top frame disposed on the second surface of the first panel and adjacent to the lateral frame.

3. The structure according to claim 2, wherein a thickness of the top frame that surrounds at least two sides of the first and second panels ranges between 10 μm and 5 mm.

4. The structure according to claim 2, wherein a thickness of the lateral frame is a sum of a thickness of the top frame, a thickness of the first panel and a thickness of the first adhesive layer.

5. The structure according to claim 2, wherein a ratio of a width of the lateral frame to a width of the top frame ranges between 1 and 4.

6. The structure according to claim 2, wherein a Young's modulus of the lateral frame and the top frame is smaller than 10 GPa.

7. The structure according to claim 6, wherein materials of the lateral frame and the top frame include rubber adhesive materials, acrylic resin adhesive materials or silicone resin adhesive materials.

8. The structure according to claim 7, wherein the rubber adhesive materials include natural rubber and synthetic rubber, and the acrylic resin adhesive materials include acrylic resins and modified acrylic resins.

9. The structure according to claim 1, wherein the first panel is a touch panel, a color filter, a planar layer, a gas barrier layer, a water barrier layer, a stress buffering layer, a scratch-resistant layer, an UV shielding layer, an anti-glare layer, an anti-fingerprint layer or an anti-reflection layer and the second panel is a display panel, or the first panel is a display panel and the second panel is a touch panel, a color filter, a planar layer, a gas barrier layer, a water barrier layer, a stress buffering layer, a scratch-resistant layer, an UV shielding layer, an anti-glare layer, an anti-fingerprint layer or an anti-reflection layer.

10. The structure according to claim 1, wherein the frame is disposed in a peripheral region of the first and second panels and surrounds at least two sides of the first and second panels.

11. The structure according to claim 10, wherein the frame disposed in the peripheral region of the first and second panels is a continuous structure.

12. The structure according to claim 10, wherein the frame disposed in the peripheral region of the first and second panels includes discontinuous structures.

13. The structure according to claim 1, wherein the frame is disposed in a peripheral region of the first and second panels and only disposed in a predetermined folding region of the first and second panels.

14. The structure according to claim 1, wherein the frame located at different sides of the first panel includes different materials.

15. The structure according to claim 1, wherein the width of the first panel is equivalent to a width of the first adhesive layer, and the frame is in direct contact with the sides of the first panel and the first adhesive layer.

16. The structure according to claim 1, wherein the width of the first panel is larger than a width of the first adhesive layer, and the frame is not in contact with the side of the first adhesive layer.

17. The structure according to claim 1, wherein the width of the first panel is larger than a width of the first adhesive layer, and the frame is in direct contact with the side of the first adhesive layer.

18. The structure according to claim 1, wherein a width of the first adhesive layer is larger than the width of the first panel, and the frame is in direct contact with the sides of the first panel and the first adhesive layer.

19. The structure according to claim 1, wherein the width of the second panel is equivalent to a width of the first adhesive layer, and the frame is in direct contact with the side of the first panel without contacting with the side of the first adhesive layer.
